(19) United States
(12) Patent Application Publication
(10) Pub. No.: US 2023/0247943 A1
(43) Pub. Date: Aug. 10, 2023

(54) Threshing Apparatus and Harvester

(71) Applicant: Kubota Corporation, Osaka-shi (JP)

(72) Inventor: Takafumi Mitsui, Sakai-shi (JP)

(21) Appl. No.: 17/927,838

(22) PCT Filed: Jun. 30, 2021
(86) PCT No.: PCT/JP2021/024781

§ 371 Date: Nov. 25, 2022

(30) Foreign Application Priority Data
Jul. 22, 2020 (JP) 2020-125585
Jul. 22, 2020 (JP) 2020-125586
Jul. 22, 2020 (JP) 2020-125587

(51) Int. Cl. A01F 12/22; A01F 7/04; A01F 7/06; A01F 12/46

(52) U.S. Cl. CPC A01F 12/22; A01F 7/04; A01F 7/06; A01F 12/46; A01F 12/10

(57) ABSTRACT

A first threshing section 15 and a second threshing section 16 are provided. The first threshing section 15 includes a first threshing drum 17 that rotates about a left-right-oriented axis, and the second threshing section 16 includes a second threshing drum 28 that rotates about a body front-rear-oriented axis. The second threshing drum 28 includes a rotary support shaft 29 extending along a front-rear direction, a plurality of rod-shaped frame bodies 30 that are arranged side by side extending along the front-rear direction and at and interval in the peripheral direction, radially outward of the rotary support shaft 29, and threshing teeth 31 attached to the frame bodies 30.

### CROSS-REFERENCE TO RELATED APPLICATIONS

This application is the United States national phase of International Application No. PCT/JP2021/024781 filed Jun. 30, 2021, and claims priority to Japanese Patent Application Nos. 2020-125585 filed Jul. 22, 2020, 2020-125586 filed Jul. 22, 2020, and 2020-125587 filed Jul. 22, 2020, the disclosures of which are hereby incorporated by reference in their entireties.

### BACKGROUND OF THE INVENTION

### Field of the Invention

The present invention relates to a threshing apparatus for threshing harvested crops and a harvester equipped with the threshing apparatus.

### Description of Related Art

### Related Art 1

In a combine, which is an example of a harvester including a threshing apparatus, crops reaped by a harvesting section provided in a body front part are conveyed rearward by a grain culm conveying apparatus, and the crops are introduced into the threshing apparatus and threshed. Conventionally, the threshing apparatus included a threshing drum that includes a large number of rod-shaped threshing teeth and rotates around a front-rear-oriented axis in a threshing chamber into which the crops conveyed by the grain culm conveying apparatus are introduced (e.g., see Patent Document 1).

### Related Art 2

A threshing apparatus includes a threshing drum inside a threshing chamber, and the threshing drum includes a rotary support shaft extending in a front-rear direction of the threshing chamber, and is supported so as to be rotatable about an axis of the rotary support shaft. A plurality of rod-shaped frame bodies arranged side by side extending along the front-rear direction and at an interval in the peripheral direction are provided so as to be integrally rotatable, radially outward of the rotary support shaft, and a plurality of round rod-shaped threshing teeth extending radially outward are attached to the rod-shaped frame bodies in some cases (e.g., see Japanese Patent Application Laid-Open No. 2013-14672, Patent Document 1).

### Related Art 3

A threshing apparatus includes a threshing drum inside a threshing chamber, and the threshing drum is provided with a rotary support shaft extending in a front-rear direction of the threshing chamber and is supported so as to be rotatable about the axis of the rotary support shaft. Conventionally, a plurality of rod-shaped frame bodies arranged side by side extending along the front-rear direction and at an interval in the peripheral direction are provided so as to be integrally rotatable, radially outward of the rotary support shaft, a plurality of threshing teeth extending radially outward are attached to the rod-shaped frame body, and as the threshing teeth, round rod-shaped teeth of the same configuration are provided over the entire region in the front-rear direction of the threshing drum (e.g., see Patent Document 1).

### Patent Documents

Patent Document 1: Japanese Patent Application Laid-Open No. 2013-14672

### SUMMARY OF THE INVENTION

### Problem 1

The problem corresponding to [Related Art 1] is as follows.

In the above-described conventional configuration, if the threshing amount per unit time is within a set range, threshing can be performed favorably. Recently, however, there has been demand to increase the threshing amount per unit time so that threshing work can be performed more efficiently.

In order to meet such demand, it is conceivable to lengthen the threshing drum in the front-rear direction to increase the threshing amount in the threshing chamber. In such a configuration, the threshing drum is enlarged in the front-rear direction, and there is a risk that the driving load when rotating the threshing drum will become excessive. Also, in the above-described conventional configuration, the width by which the crops are introduced into the threshing chamber is a width corresponding to the lateral width of the threshing drum, and therefore cannot be made so large. As a result, it is not possible to widen the width by which the crops are introduced into the threshing chamber, and therefore there is a risk that the threshing amount will also be suppressed.

In view of this, there is demand for a threshing apparatus that has a compact configuration overall and that is capable of suppressing the threshing load and increasing the threshing processing capacity, and a harvester including the threshing apparatus.

### Problem 2

The problem corresponding to [Related Art 2] is as follows. In the above-described conventional configuration, since a strong threshing force acts on the crop due to the round rod-shaped threshing teeth that protrude radially outward, favorable threshing can be performed even when harvesting a crop that does not shed easily, such as rice, for example. However, when harvesting crops such as wheat and soybeans, which shed more easily than rice, the threshing force may be too strong, damaging the grains. Also, when the threshed stalk waste (straw waste) is to be used as animal feed, there is a disadvantage that the grain culms are severely damaged and may become unsuitable as animal feed, or the like. There was a disadvantage.

In view of this, there has been demand for a threshing apparatus capable of appropriately threshing grains and stalk waste of crops to be harvested without damaging them.

### Problem 3

The problem corresponding to [Related Art 3] is as follows.

In the above-described conventional configuration, since a strong threshing force acts on the crop due to the round rod-shaped threshing teeth that protrude radially outward, favorable threshing can be performed even when harvesting a crop that does not shed easily, such as rice, for example. However, when harvesting crops such as wheat and soybeans, which shed more easily than rice, the threshing force may be too strong, damaging the grains. Also, when the stalk waste (extracted straw) after threshing is to be used as animal feed, there is a disadvantage that the grain culms may be severely damaged and may become unsuitable as animal feed, and appropriate threshing processing cannot be performed according to differences in the harvested crop.

In view of this, there has been demand for a threshing apparatus capable of performing appropriate threshing according to the difference in the types of crops to be harvested.

The solution corresponding to [Problem 1] is as follows.

A characteristic configuration of the threshing apparatus according to the present invention includes: a first threshing section configured to thresh an introduced crop; and a second threshing section that is provided rearward of the first threshing section and configured to thresh a threshing material threshed by the first threshing section, in which the first threshing section includes a first threshing drum configured to rotate about a left-right-oriented axis, the second threshing section includes a second threshing drum configured to rotate about a body front-rear-oriented axis, and the second threshing drum includes: a rotary support shaft rotatably provided in an orientation along a front-rear direction; a plurality of rod-shaped frame bodies arranged side by side extending along the front-rear direction at an interval in a peripheral direction, radially outward of the rotary support shaft; and threshing teeth attached to the frame bodies.

According to the present invention, the introduced crop is first threshed by the first threshing drum that rotates about the left-right-oriented axis in the first threshing section. The width of the first threshing drum in the front-rear direction corresponds to the diameter of the threshing drum, making it compact. On the other hand, the width of the first threshing drum in the left-right direction is the width in the axial direction, and can be increased in order to increase the processing amount. Even if the conveying width when introducing the crop is widened to increase the conveying amount of the crop, the first threshing drum receiving the crop can receive a large amount of the crop due to the width in the left-right direction being enlarged.

The threshing material that has been threshed in the first threshing section is then threshed by the second threshing drum that rotates about the front-rear-oriented axis in the second threshing section. The region inside the second threshing drum surrounded by the plurality of rod-shaped frame bodies is an open space, and in response to the amount of threshing material increasing, the threshing material enters the space inside the threshing drum and does not get stuck in the narrow region between the threshing teeth and the receiving net on the outer peripheral side. As a result, it is easy to perform favorable threshing while avoiding an excessive threshing load.

Accordingly, it is possible to provide a threshing apparatus which has a compact structure overall, and which can suppress the threshing load and increase the threshing capacity.

In the present invention, it is preferable to further include an intermediate conveying apparatus configured to convey threshing material threshed by the first threshing section to the second threshing section.

According to this configuration, the intermediate conveying apparatus smoothly transfers the threshing material from the first threshing section to the second threshing section. Accordingly, it is possible to smoothly transfer the processing material without stopping on the way.

In the present invention, it is preferable that the intermediate conveying apparatus conveys the threshing material to the second threshing section without leaking the threshing material downward.

According to this configuration, after being threshed in the first threshing section, the threshing material including threshed grains and the like can be reliably transferred to the second threshing section.

In the present invention, it is preferable that a lower end position of the intermediate conveying apparatus is at a location higher than a lower end position of the first threshing section, and the second threshing section provided continuously with a rear end of the intermediate conveying apparatus is provided in a rearward-rising inclined orientation.

According to this configuration, the threshing material threshed by the first threshing drum in the first threshing section and discharged rearward is transferred while being continuously rotated by the first threshing drum. Since the lower end position of the intermediate conveying apparatus is higher than the lower end position of the first threshing section, the threshing material moves to a higher position while being continuously rotated by the first threshing drum, and then is transferred to the intermediate conveying apparatus. As a result, threshing can be preferably performed by making the range of threshing performed by the first threshing drum as large as possible.

In the present invention, it is preferable that a rearward-rising inclination angle of a virtual line connecting the lower end position of the first threshing section and the lower end position of the intermediate conveying apparatus is set to be greater than a rearward-rising inclination angle of the second threshing section.

According to this configuration, due to the second threshing section having a rearward-rising inclination, threshing can be sufficiently performed by retaining the threshing material in the second threshing section. However, if the inclination angle is too large, there is a risk that the rearward transfer of the threshing material will be delayed, and the threshing will become excessive, damaging the threshing material. In view of this, by setting the rearward-rising inclination of the second threshing drum to be gentler than that of the first threshing section and the intermediate conveying apparatus, it is possible to perform appropriate threshing with little damage.

In the present invention, it is preferable to further include: a raking section having a spiral blade at a front part of the second threshing drum; and a guide body that is located below the raking section and is configured to receive the threshing material raked rearward by the raking section and guide the threshing material rearward without leaking the threshing material downward.

According to this configuration, by raking the processing material rearward with the raking section, transfer can be performed smoothly. When the processing material is guided rearward by the raking section, the processing material is received by the guide body and does not leak downward, and therefore it is possible to convey the processing material together with the threshed grains and the like rearward without waste.

In the present invention, it is preferable to further include: a first receiving net provided along an outer periphery of the first threshing drum; a second receiving net provided along an outer periphery of the second threshing drum; and a sorting section configured to sort the threshing material leaked by the first receiving net and the threshing material leaked by the second receiving net, in which the sorting section includes a grain pan that extends along a region below the second threshing section from a region below the first threshing section.

According to this configuration, the processing material leaked from the first receiving net is received by the grain pan and transferred rearward as-is, and is sorted into grains, straw waste, and the like by the grain sorting apparatus. That is, the grain sorting apparatus need only be provided below the second threshing section, and there is no need to provide the grain sorting apparatus below the first threshing section, whereby compactness can be achieved in the up-down direction.

In the present invention, it is preferable that a rear end of the grain pan extends to a position below a front end of the second receiving net.

According to this configuration, the processing material leaked from the first receiving net is transferred to the location where the processing material leaks from the second receiving net, and therefore the processing material leaked from the first receiving net and the processing material leaked from the second receiving net are mixed and can be sorted efficiently.

In the present invention, it is preferable that the second threshing drum includes a first threshing processing section on a front side and a second threshing processing section on a rear side, the frame body in the first threshing processing section and the frame body in the second threshing processing section are provided in a divided state, and the frame body in the first threshing processing section and the frame body in the second threshing processing section are provided in different phases in a peripheral direction.

According to this configuration, the frame body of the first threshing processing section and the frame body of the second threshing processing section can be attached at different positions in the peripheral direction at the connection location between the first threshing processing section and the second threshing processing section. For example, if both are provided in the same phase, it may be difficult to perform the attachment task. On the other hand, in this configuration, since the phases are different, a space for attachment can be ensured and the task can be easily performed.

In the present invention, it is preferable that the second threshing drum includes a first threshing processing section on a front side and a second threshing processing section on a rear side, and the threshing teeth of the first threshing processing section and the threshing teeth of the second threshing processing section have mutually different shapes.

According to this configuration, for example, in the case of a crop that sheds relatively easily, and whose stalk waste should be shredded finely, the first threshing processing section threshes the crops without damaging them in an early stage of the first half with use of threshing teeth that do not have a very strong threshing force on the crop. Moreover, the second threshing processing section can separate the remaining grains and stalk waste with use of threshing teeth with a stronger threshing force, and thus appropriate threshing is possible.

Also, if it is not desirable to damage the stalk waste after grain shedding, the first threshing processing section can appropriately perform threshing of the crop with use of threshing teeth with a strong threshing force on the crop, and the second threshing processing section can perform appropriate threshing with suppressed damage to the stalk waste by using threshing teeth that do not have a very strong threshing force on the crop.

A characteristic configuration of the harvester according to the present invention includes: a harvesting section that is provided on a vehicle body front part and configured to harvest a crop; a crop conveying apparatus configured to convey the crop harvested by the harvesting section rearward; a first threshing section configured to thresh the crop conveyed by the crop conveying apparatus; and a second threshing section configured to thresh a threshing material threshed by the first threshing section, in which the first threshing section includes a first threshing drum configured to rotate about a left-right-oriented axis, the second threshing section includes a second threshing drum configured to rotate about a body front-rear-oriented axis, and the second threshing drum includes: a threshing drum shaft extending along a front-rear direction; a plurality of rod-shaped frame bodies arranged side by side extending along the front-rear direction and at an interval in a peripheral direction, radially outward of the rotary support shaft; and threshing teeth attached to the frame bodies.

According to this configuration, the crop is harvested in the harvesting section while the machine body is traveling, the crop is conveyed rearward by the crop conveying apparatus and introduced into the first threshing section. First, in the first threshing section, the introduced crop is threshed by the first threshing drum that rotates about the left-right-oriented axis. Next, in the second threshing section, threshing is performed by the second threshing drum that rotates about the front-rear-oriented axis.

The width in the front-rear direction of the first threshing drum corresponds to the diameter of the threshing drum, making it compact. On the other hand, the width in the left-right direction of the first threshing drum is the width in the axial direction, and can be increased in order to increase the processing amount. A large amount of crops can be received by widening the width in the left-right direction of the first threshing drum for receiving the crops, even if the conveying amount of the crops is increased by widening the conveying width when the crops are conveyed by the crop conveying apparatus.

The region inside the second threshing drum surrounded by the plurality of rod-shaped frame bodies is an open space, and in response to the amount of threshing material increasing, the threshing material enters the space inside the threshing drum and does not get stuck in the narrow region between the threshing teeth and the receiving net on the outer peripheral side. As a result, it is easy to perform favorable threshing while avoiding an excessive threshing load.

Accordingly, it has been possible to provide a harvester that has a compact threshing apparatus overall and can suppress the threshing load and increase the threshing capacity.

In the present invention, it is preferable to further include an intermediate conveying apparatus configured to convey threshing material threshed by the first threshing section to the second threshing section.

According to this configuration, the intermediate conveying apparatus smoothly transfers the threshing material from the first threshing section to the second threshing section. Accordingly, it is possible to smoothly transfer the processing material without stopping on the way.

The solution corresponding to [Problem 2] is as follows.

A characteristic configuration of the threshing apparatus according to the present invention includes: a threshing chamber; and a threshing drum that is rotatably provided in the threshing chamber and configured to perform threshing of a crop introduced into a front part of the threshing chamber, in which the threshing drum includes: a rotary support shaft rotatably provided in an orientation along a front-rear direction of the threshing chamber, a plurality of rod-shaped frame bodies arranged side by side extending along the front-rear direction and at an interval in a peripheral direction, radially outward of the rotary support shaft, and threshing teeth fixed to the frame bodies, and the threshing teeth are rasp threshing teeth with recesses and protrusions formed on a surface thereof, and are configured to thresh the crop with use of the shape of the recesses and protrusions on the surface.

According to the present invention, rasp threshing teeth that have recesses and protrusions formed on the surface thereof and thresh the crop due to the shape of the recesses and protrusions on the surface are used as the threshing teeth fixed to the frame body. Compared to the rod-shaped threshing teeth extending radially outward, the rasp threshing teeth have a weaker threshing force on the crop, and therefore even if the crop sheds easily, there is little risk that the rasp threshing teeth will act with a strong force on the shed grains and damage them.

Accordingly, it is possible to provide a threshing apparatus capable of performing appropriate threshing without damaging the grains and stalk waste of the harvested crop.

In the present invention, it is preferable that the rasp threshing teeth are supported on a support base attached to the frame body.

If the rasp threshing teeth are directly attached to the frame body, the structure of the frame body, which is a large-sized member, may become complicated, and for example, the frame body may include a weld nut. On the other hand, according to this configuration, by supporting the rasp threshing teeth on the support base, it is possible to support the rasp threshing teeth without complicating the configuration of the frame body.

In the present invention, it is preferable that a plurality of the support bases are attached to the frame bodies at intervals along an axial direction of the threshing drum.

According to this configuration, since the support base is a small and lightweight member, it is easy to perform the attachment task of attaching the support base to the frame body.

In the present invention, it is preferable that the rasp threshing teeth are removably supported by the support base.

The rasp threshing teeth may wear with long-term use. With this arrangement, the rasp threshing teeth can be removed, and therefore the rasp threshing teeth can be easily replaced when worn.

In the present invention, it is preferable that the rasp threshing teeth are in a rod shape extending along a longitudinal direction of the frame body.

According to this configuration, since the rasp threshing teeth are rod-shaped, for example, compared to a configuration in which a large number of small rasp threshing teeth that are short in the longitudinal direction of the frame body are attached to the frame body, the assembly task can be easily performed without difficulty.

In the present invention, it is preferable that a receiving net is included along an outer periphery of the threshing drum, and an interval between a rotation direction upstream portion of the rasp threshing teeth and the receiving net along a radial direction is wider compared to an interval between a rotation direction downstream portion of the rasp threshing teeth and the receiving net.

According to this configuration, when the crop is sandwiched between the rasp threshing teeth and the receiving net along with the rotation of the threshing drum and threshing is performed, the interval between the upstream portion in the rotation direction of the rasp threshing teeth and the receiving net is wide, and therefore the crop is easily introduced between the rasp threshing teeth and the receiving net, whereby threshing is smoothly performed.

In the present invention, it is preferable that the rotation direction upstream portion of the rasp threshing teeth has a smooth outer peripheral surface, and is in an inclined shape such that an interval from the receiving net along a radial direction narrows toward the rotation direction downstream side, and a rotation direction downstream portion of the rasp threshing teeth has recesses and protrusions formed on a surface thereof, and an interval between the rotation direction downstream portion and the receiving net along a radial direction is approximately the same over the entire width in the peripheral direction.

According to this configuration, since the outer peripheral surface is smooth at the rotation direction upstream portion, the threshing material is smoothly introduced between the rasp threshing teeth and the receiving net. After being introduced, threshing is performed between the rotation direction downstream portion of the rasp threshing teeth and the receiving net. In addition, the rotation direction downstream portion is at the same interval from the receiving net over the entire width in the peripheral direction, and thus threshing can be performed favorably.

In the present invention, it is preferable that the rasp threshing teeth are attached to a support base supported on the frame body, the support base includes an upstream support portion supporting a rotation direction upstream portion of the rasp threshing teeth, and a downstream support portion supporting a rotation direction downstream portion of the rasp threshing teeth, the upstream support portion is in a shape extending along the rotation direction upstream portion of the rasp threshing teeth, and the downstream support portion is in a shape extending along the rotation direction downstream portion of the rasp threshing teeth.

According to this configuration, the rotation direction downstream portion and the rotation direction upstream portion of the rasp threshing teeth are received and supported while in approximately planar contact with an upstream support portion and a downstream support portion of the support base. As a result, the threshing can be favorably performed without disadvantages such as bending and deformation of the rasp threshing teeth due to a reaction force from the threshing material.

In the present invention, it is preferable that the support base is attached with a gap formed between the downstream support portion and the frame body, and the rotation direction downstream portion of the rasp threshing teeth and the downstream support portion are supported by being fastened by a bolt mounted from above and a nut included in the gap between the downstream support portion and the frame body.

According to this configuration, the bolt is mounted from above so as to pass through the rasp threshing teeth and the support base, and is fastened and fixed to the nut. The nut can be provided without protruding outward by using the gap between the downstream support portion of the support base and the frame body.

In the present invention, it is preferable that the threshing drum includes another threshing processing section rearward of the threshing processing section having the rasp threshing teeth.

According to this configuration, since the other threshing processing section is included, it is possible to perform processing that cannot be sufficiently handled in the threshing using the rasp threshing teeth by using a different type of threshing teeth from the rasp threshing teeth in the other threshing processing section.

The solution corresponding to [Problem 3] is as follows.

A characteristic configuration of the threshing apparatus according to the present invention includes: a threshing chamber; and a threshing drum that is rotatably provided in the threshing chamber and configured to perform threshing of a crop introduced into a front part of the threshing chamber, in which the threshing drum includes: a rotary support shaft rotatably provided in an orientation along a front-rear direction of the threshing chamber; a plurality of rod-shaped frame bodies arranged side by side extending along the front-rear direction and at an interval in a peripheral direction, radially outward of the rotary support shaft, and threshing teeth fixed to the frame bodies, the threshing drum includes a first threshing processing section in a front portion and a second threshing processing section in a rear portion, and the threshing teeth of the first threshing processing section and the second threshing processing section have mutually different shapes.

According to the present invention, the region inside the threshing drum surrounded by the plurality of rod-shaped frame bodies is an open space, and when the amount of threshing material increases, the threshing material enters the space inside the threshing drum and does not get stuck in the narrow region between the threshing teeth and the outer receiving net. As a result, an excessive threshing load can be avoided and favorable threshing is easily performed.

The first threshing processing section on the front side of the threshing drum and the second threshing processing section on the rear side of the threshing drum have threshing teeth with mutually different shapes. For example, in the case of a crop that sheds relatively easily, and whose stalk waste should be finely shredded, the first threshing processing section uses threshing teeth that do not have a very strong threshing force on the crop so as not to damage the crop at an early stage in the first half, and the remaining grains and stalk waste can be separated and appropriate threshing can be performed by the second threshing processing section with use of threshing teeth having a stronger threshing force.

Also, if it is not desirable to damage the stalk waste after grain shedding, the first threshing processing section can appropriately perform threshing of the crops with use of threshing teeth with a strong threshing force on the crop, and the second threshing processing section can perform appropriate threshing with suppressed damage to the stalk waste by using threshing teeth that do not have a strong threshing force on the crop.

Accordingly, it is possible to avoid the disadvantage of damaging grains, stalk waste, and the like due to the strong threshing force acting on the entire region in the front-rear direction of the threshing drum, and to perform appropriate threshing according to differences in the crops to be harvested.

In the present invention, it is preferable that the first threshing processing section includes one of first threshing teeth that have recesses and protrusions on a surface thereof and thresh a crop with use of the shape of the recesses and protrusions on the surface, and second threshing teeth that extend radially outward in a rod shape, and the second threshing processing section includes the other of the first threshing teeth and the second threshing teeth.

According to this configuration, since the first threshing teeth thresh the crop with use of the shape of the recesses and protrusions formed on the surface, the threshing force on the crop is weaker than that of the rod-shaped threshing teeth extending radially outward. However, it is possible to perform favorable threshing on crops that easily shed, and there is little risk of damaging the threshed grains. On the other hand, the rod-shaped threshing teeth exert a strong threshing force, and can efficiently shed even crops that are difficult to shed.

By including one of the first threshing teeth or the second threshing teeth in the first threshing processing section and the other in the second threshing processing section, appropriate threshing can be performed according to the properties of the crop and the necessary threshing method.

In the present invention, it is preferable that the first threshing processing section includes the first threshing teeth, and the second threshing processing section includes the second threshing teeth.

Since a large amount of crops are processed in the front half of the threshing drum, the drive load may become excessive if the second threshing teeth that exert a strong threshing force are included. In view of this, in this configuration, by including the first threshing teeth in the first threshing processing section, for example, if the crop sheds easily, the threshing can be performed favorably while avoiding an excessive drive load.

In the present invention, it is preferable that the first threshing teeth are in a rod shape extending along a longitudinal direction of the frame body.

According to this configuration, since the first threshing teeth are rod-shaped, for example, compared to a configuration in which a large number of small first threshing teeth that are short in the longitudinal direction of the frame body are attached to the frame body, the attachment task can be easily performed without difficulty.

In the present invention, it is preferable that a path of an outer end of the threshing drum in the first threshing processing section and a path of an outer end of the threshing drum in the second threshing processing section are at the same position in a view in an axial direction of the rotary support shaft.

According to this configuration, since the gaps between the outer end of the threshing drum and the receiving net in the first threshing processing section and the second threshing processing section are the same, it is possible to smoothly transfer the processing material that is to be transferred from the first threshing processing section to the second threshing processing section without retaining the processing material, while the processing material is threshed by being kneaded between the outer end of the threshing drum and the receiving net.

In the present invention, it is preferable that an interval in a radial direction between the frame body and the rotary support shaft in the first threshing processing section and an interval in a radial direction between the frame body and the rotary support shaft in the second threshing processing section are different from each other.

According to this configuration, the height in the radial direction of the threshing teeth included in the first threshing processing section and the second threshing processing section can be set to a needed height while making the path of the outer end of the threshing drum the same.

In the present invention, it is preferable that the second threshing teeth are inclined such that that a radial outer side thereof is located on a rotation direction downstream side of the threshing drum relative to an inner side thereof in a view in the axial direction of the rotary support shaft.

According to this configuration, the second threshing teeth are inclined such that the radial outer side thereof is located on the rotation direction downstream side, and have a sweepback angle, and therefore when threshing is performed on the crop, the second threshing teeth are easily pulled out of the crops, and there is little risk that they will get entangled and rotate together.

In the present invention, it is preferable that the second threshing teeth include a planar threshing surface, and the threshing surface is in an inclined orientation in which a rear portion thereof is located downstream in a rotation direction.

According to this configuration, the crop is introduced into the front part of the threshing chamber and discharged from the rear part of the threshing chamber. However, when the threshing surface of the second threshing teeth performs threshing, a force that pushes toward the downstream side in the processing material transfer direction acts on the threshing material. As a result, it is possible to assist the rearward transfer of the threshing material.

In the present invention, it is preferable that the second threshing teeth are in a vertically elongated shape that is elongated in a radial direction and fixing portions for fixing to the frame body are formed at locations spaced apart from a center in a longitudinal direction by an equal distance.

According to this configuration, when the radial outer side of the second threshing teeth wears during use, the second threshing teeth are reversed around the center in the longitudinal direction, and the fixing portion on the opposite side is fixed to the frame body. As a result, favorable threshing can be performed with the portion on the opposite side in the longitudinal direction to the worn portion on the radial outward side, without changing the distance from the receiving net.

In the present invention, it is preferable that a plurality of the second threshing teeth are attached at intervals in the longitudinal direction of the frame body and are arranged side by side in a spiral shape around an outer periphery of the frame body.

According to this configuration, since the second threshing teeth are arranged side by side in a spiral shape around the outer periphery of the frame body, the rearward transfer can be performed more easily by guiding the threshing material while transferring it toward the adjacent second threshing teeth.

In the present invention, it is preferable that the frame body of the first threshing processing section and the frame body of the second threshing processing section are provided in a divided state, and the frame body of the first threshing processing section and the frame body of the second threshing processing section are provided in different phases in a peripheral direction.

According to this configuration, the frame body of the first threshing processing section and the frame body of the second threshing processing section can be attached at different positions in the peripheral direction at the connection location between the first threshing processing section and the second threshing processing section. For example, if both are provided in the same phase, it may be difficult to perform the attachment task. On the other hand, in this configuration, due to the phases being different, a space for attachment can be ensured and the task is easily performed.

In the present invention, it is preferable that the frame body of the first threshing processing section and the frame body of the second threshing processing section are provided in a divided state, and the frame body of the first threshing processing section is attachable to the second threshing processing section as well, and the frame body of the second threshing processing section is attachable to the first threshing processing section as well.

According to this configuration, the frame body of the first threshing processing section and the frame body of the second threshing processing section can be used interchangeably. For example, when the types of crops are different, it is possible to exhibit a suitable threshing action even if the types of crops to be harvested are different by adopting a configuration in which the threshing teeth included on the frame body of the first threshing processing section are used in the second threshing processing section, a configuration in which the threshing teeth included on the frame body of the second threshing processing section are used in the first threshing processing section, and the like.

### BRIEF DESCRIPTION OF THE DRAWINGS

FIG. 1 is an overall side view of a combine.

FIG. 2 is a lateral cross-sectional plan view of a threshing apparatus.

FIG. 3 is a vertical cross-sectional side view of the threshing apparatus.

FIG. 4 is a side view of a second threshing drum.

FIG. 5 is a cross-sectional view taken along line V-V in FIG. 3.

FIG. 6 is a cross-sectional view taken along line VI-VI in FIG. 3.

FIG. 7 is a vertical cross-sectional front view of the threshing apparatus.

FIG. 8 is a vertical cross-sectional front view showing first threshing teeth.

FIG. 9 is a partial perspective view of the first threshing teeth.

FIG. 10 is a plan view showing an attached state of second threshing teeth.

FIG. 11 is a perspective view showing an attached state of the second threshing teeth.

FIG. 12 is a plan view showing a supported state of a debris transport valve.

FIG. 13 is a vertical sectional plan view showing a supported state of the debris transport valve.

FIG. 14 is a plan view of a first angle adjusting mechanism.

### DESCRIPTION OF THE INVENTION

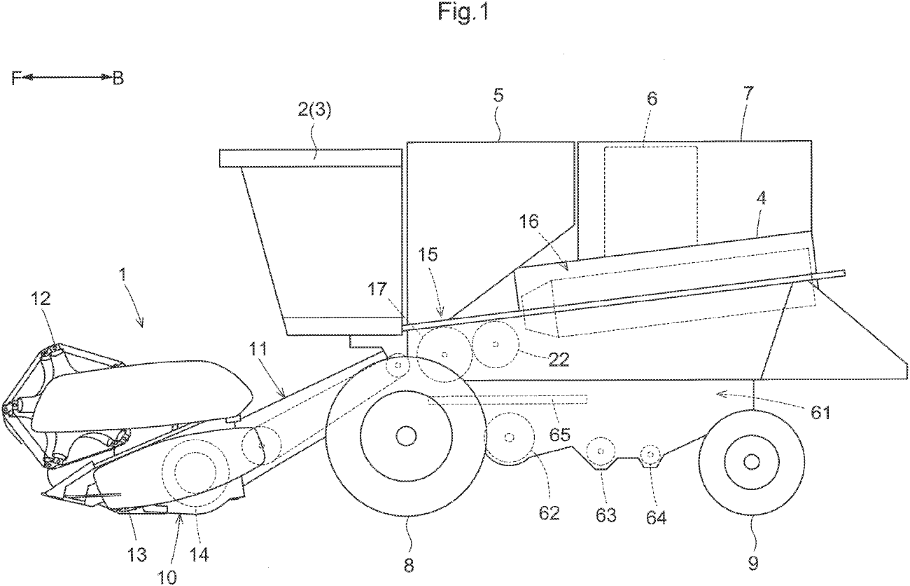

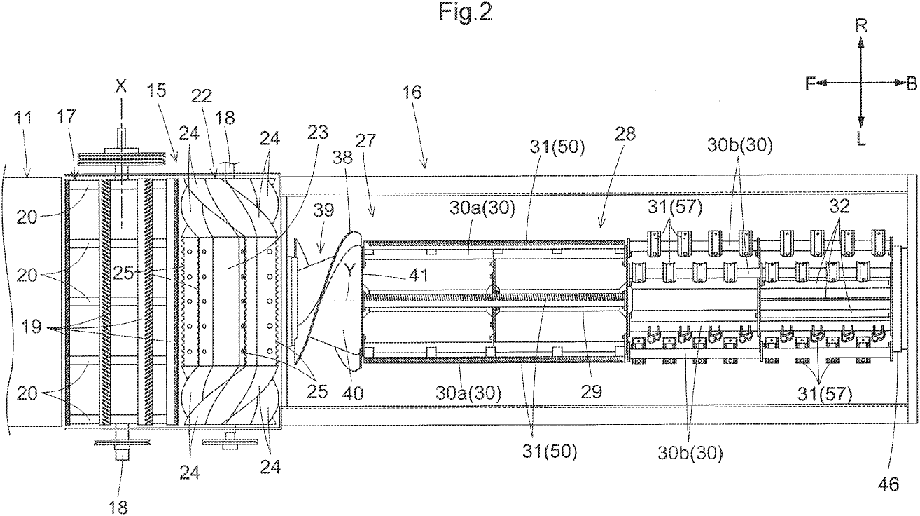

Hereinafter, a case will be described where an embodiment of a threshing apparatus according to the present invention is applied to a threshing apparatus for a common combine, with reference to the drawings. In this embodiment, the direction indicated by reference sign (F) is the body front side, and the direction indicated by reference sign (B) is the body rear side (see FIGS. 1, 2, and 3). The direction indicated by reference sign (L) is the body left side, and the direction indicated by reference sign (R) is the body right side (see FIGS. 2, 5, 6, and 7).

### Overall Configuration of Combine

As shown in FIG. 1, the combine includes a reaping/conveying section 1 that reaps crops and conveys them rearward, a driving section 3 that is covered by a cabin 2, a threshing apparatus 4 that threshes the crops reaped by the reaping/conveying section 1, a grain tank 5 for storing grains obtained by threshing in the threshing apparatus 4, a motor section 7 having an engine 6 serving as a motive power source, left and right front wheels 8, left and right rear wheels 9, and the like.

The reaping/conveying section 1 includes a reaping section 10 serving as a harvesting section that reaps planted crops and gathers the reaped crops in the center in the cutting width direction, and a feeder 11 serving as a crop conveying apparatus that conveys the crops that were reaped and gathered in the center, toward the threshing apparatus 4 in the body rear side. Although not described in detail, the reaping section 10 includes a rotary reel 12 that rakes the ear tip side of the crops to be reaped rearward, a reaping blade 13 that performs reaping by cutting the root base of the crops, a lateral feeding auger 14 that gathers the reaped crops to the center in the reaping width direction, and the like.

A threshing apparatus 4 that receives and threshes the reaped grain culms transported by the feeder 11 as threshing material and sorts the threshing material is provided rearward of the reaping/conveying section 1. A grain tank 5 for collecting and storing single grains conveyed from the threshing apparatus 4 is provided above the front part of the threshing apparatus 4. The motor section 7 is provided above the rear part of the threshing apparatus 4.

### Threshing Apparatus

Next, the threshing apparatus 4 will be described.

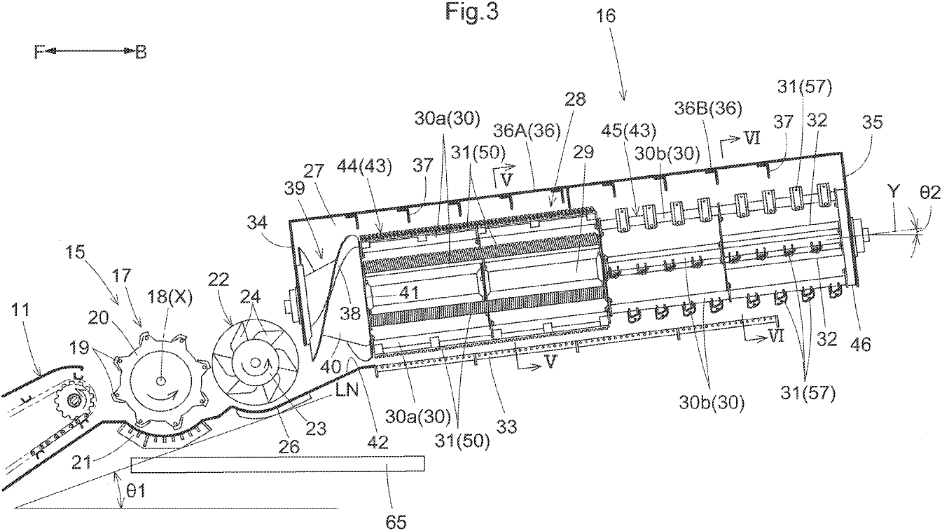

As shown in FIGS. 2 and 3, the threshing apparatus 4 includes a first threshing section 15 where harvested crops are conveyed and threshed, and a second threshing section 16 that is provided rearward of the first threshing section 15, and where the threshing material processed by the first threshing section 15 is introduced and threshed. The first threshing section 15 has substantially the same width in the left-right direction as the feeder 11 and is wider than the second threshing section 16.

### First Threshing Section

The first threshing section 15 will be described.

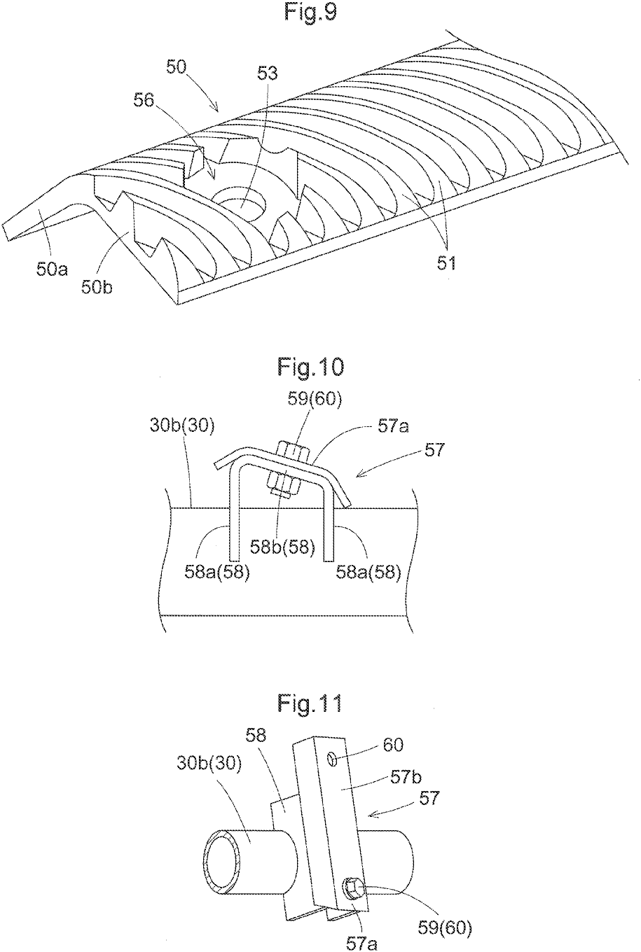

The first threshing section 15 includes a first threshing drum 17 that rotates about a left-right-oriented axis X. The first threshing drum 17 includes a rotary support shaft 18 that extends along the left-right direction and is rotatable, a plurality of rod-shaped threshing teeth 19 that extend in the left-right direction and are spaced apart in the peripheral direction, a plurality of support members 20 that support the plurality of rod-shaped threshing teeth 19 on the rotary support shaft 18 in a state where the radial distance from the rotary support shaft 18 is the same and in a state where they can rotate together. The threshing teeth 19 are formed in a rod shape extending in the left-right direction over the entire width in the left-right direction of the first threshing drum 17, and constituted by rasp threshing teeth (see FIG. 9) that have a surface with recesses and protrusions and thresh the crops with use of the shape of the recesses and protrusions on the surface.

The support members 20 are constituted by plate bodies that are substantially star-shaped in a view from the side, and a plurality thereof are provided at an interval in the left-right direction. The center of the support member 20 is fixed to the rotary support shaft 18 and is supported so as to be integrally rotatable. The threshing teeth 19 are fixed to the plurality of support members 20 by fastening bolts.

A first receiving net 21 is provided in a region below the first threshing drum 17 in the outer peripheral portion of the first threshing drum 17. When the first threshing drum 17 is rotated counterclockwise in FIG. 3 by a driving mechanism (not shown), the crop conveyed by the feeder 11 is raked in by the threshing teeth 19, and threshing is performed due to strokes by the threshing teeth 19, kneading between the threshing teeth 19 and the first receiving net 21, and the like.

An intermediate conveying apparatus 22 that conveys the threshing material threshed in the first threshing section 15 to the second threshing section 16 is provided between the first threshing section 15 and the second threshing section 16. The intermediate conveying apparatus 22 conveys the threshing material toward the second threshing processing section 16 without leaking downward.

The width in the left-right direction of the intermediate conveying apparatus 22 is the same as the width in the left-right direction of the first threshing section 15. The intermediate conveying apparatus 22 includes a cylindrical drum 23 that has a left-right-oriented axis and extends over the entire width in the left-right direction, spiral blades 24 provided on both left and right sides of the outer periphery of the drum 23, a plurality of raking members 25 provided in the center in the left-right direction of the outer periphery of the drum 23, and a semi-cylindrical bottom plate 26.

The left and right spiral blades 24 are fixed to the outer periphery of the drum 23 and provided in a state in which the feeding directions are opposite to each other. The raking member 25 is fixed to the outer periphery of the drum 23 and is constituted by a plate-shaped member extending radially outward. A plurality of raking members 25 are provided at appropriate intervals in the peripheral direction of the drum 23.

When a driving mechanism (not shown) rotates the drum 23 counterclockwise as shown in FIG. 3, the left and right spiral blades 24 horizontally feed the threshing material so as to gather it in the center in the left-right direction. After being gathered in the center, the threshing material is raked rearward by the raking member 25 and introduced into the second threshing section 16.

The second threshing section 16 includes a threshing chamber 27 for threshing the introduced threshing material. Although the threshing chamber 27 will be described later, the width in the left-right direction of the threshing chamber 27 is narrower than the width in the left-right direction of the intermediate conveying apparatus 22. The left and right spiral blades 24 are provided in regions of the intermediate conveying apparatus 22 that protrude outward on both sides in the left and right direction from both left and right end portions of the threshing chamber 27. Accordingly, the intermediate conveying apparatus 22 gathers the threshing material in the center in the left-right direction, and then can smoothly introduce it into the rearward threshing chamber 27.

As shown in FIG. 3, the lower end position of the intermediate conveying apparatus 22 is located higher than the lower end position of the first threshing section 15. The second threshing section 16 is provided so as to be continuous with the rear end portion of the intermediate conveying apparatus 22.

### Second Threshing Section

The second threshing section 16 will be described.

As shown in FIGS. 1 and 3, the second threshing section 16 is in a rearward-rising inclined orientation. The second threshing section 16 includes a threshing chamber 27, and the threshing chamber 27 includes a second threshing drum 28 that rotates about a front-rear-oriented axis Y. The second threshing drum 28 is in a rearward-rising inclined orientation, and the axis Y is also in a rearward-rising inclined orientation.

The rearward rising inclination angle θ1 of a virtual line LN connecting the lower end position of the first threshing section 15 and the lower end position of the intermediate conveying apparatus 22 is set larger than the rearward rising inclination angle θ2 of the second threshing section 16. That is, compared to the degree of rearward rising from the first threshing section 15 to the intermediate conveying apparatus 22, the degree of rearward rising of the second threshing section 16 is smaller.

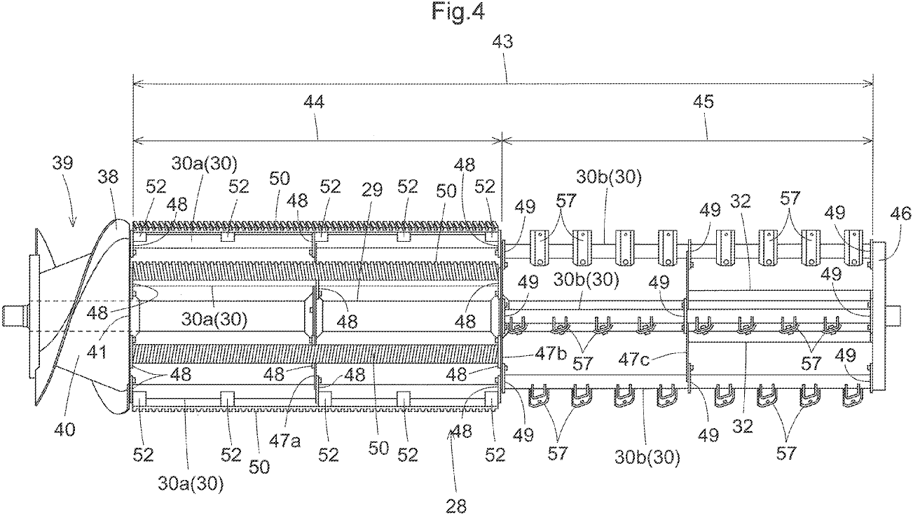

As shown in FIGS. 4 to 7, the second threshing drum 28 includes a rotary support shaft 29 that extends along the front-rear direction and is rotatable, a plurality of rod-shaped frame bodies 30 arranged side by side extending along the front-rear direction and at an interval in a peripheral direction, radially outward of the rotary support shaft 29, and threshing teeth 31 attached to the frame bodies 30. The frame bodies 30 are made of round pipe steel.

The rotary support shaft 29 of the second threshing drum 28 is made of one piece extending from the front end to the rear end of the second threshing drum 28, and is elongated in the front-rear direction. A self-aligning bearing is used as a bearing member that rotatably supports both front and rear sides of the rotary support shaft 29. Although not shown, the second threshing drum 28 is rotationally driven by transmission of motive power to the rear side. When the processing material is clogged or the like and the threshing drum is locked, a force acts on the rear portion of the rotary support shaft 29 in a twisting direction. In view of this, as shown in FIGS. 4 and 6, reinforcing ribs 32 are provided extending radially in a partial region of the rear end of the outer periphery of the rotary support shaft 29.

The second threshing drum 28 is rotationally driven in the clockwise direction (clockwise) in a front view with the rotation support shaft 29 serving as the center of rotation. The lower front portion of the threshing chamber 27 includes an opening that allows the threshing material to be introduced into the threshing chamber 27. A region below the second threshing drum 28 in the surrounding area of the second threshing drum 28 is equipped with a second receiving net 33.

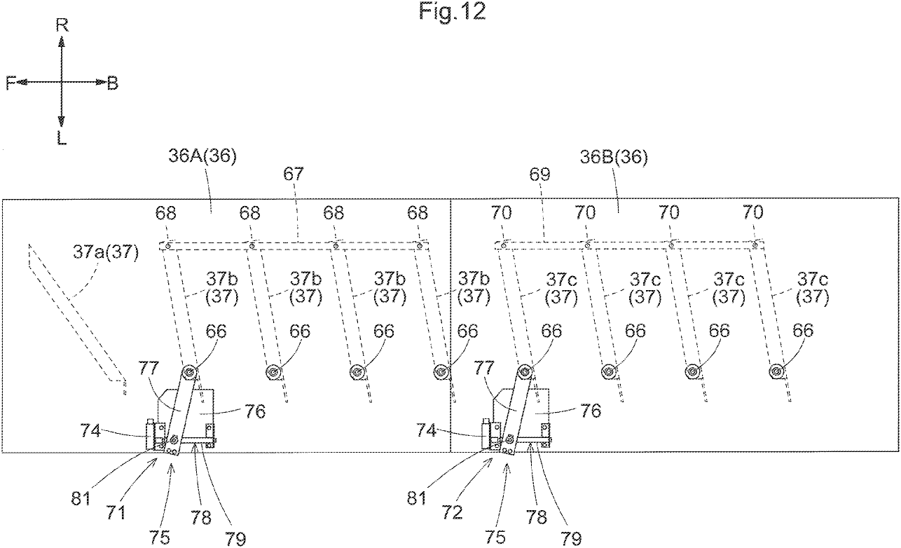

As shown in FIG. 3, the threshing chamber 27 is defined by a front support wall 34 and a rear support wall 35 that support the second threshing drum 28, a top plate 36 provided above the second threshing drum 28, a second receiving net 33, and the like. A plurality of debris transport valves 37 that are arranged side by side in the front-rear direction of the threshing chamber 27 are provided inside the top plate 36. As shown in FIG. 12, the top plate 36 can be divided in the front and rear at a dividing point provided in the center of the threshing chamber 27 in the front-rear direction. Normally, a first top plate 36A located on the front side and a second top plate 36B located on the rear side are bolted together at the division point in the center in the front-rear direction. When it is to be removed for maintenance or the like, the bolt connection is released, the top plate 36 can be divided in the front and rear and taken out rearward.

The front part of the second threshing drum 28 is provided with a raking section 39 having a spiral blade 38. The raking section 39 has a spiral blade 38 integrally fixed to the outer periphery of a tapered drum 40. A front end of the drum 40 is joined to the rotary support shaft 29. A rear end of the drum 40 is joined to a rotary support shaft 29 via a front support member 41. As the rotary support shaft 29 rotates, the raking section 39 rakes the introduced threshing material rearward using the feed action of the spiral blades 38.

As shown in FIG. 3, below the raking section 39, a guide body 42 that receives the threshing material raked in by the raking section 39 and guides the received threshing material rearward without leaking it downward is included. The guide body 42 is constituted by a plate body that is bent in a substantial arc shape in a front view so as to extend along the lower outer periphery of the spiral blade 38. The guide body 42 is provided so as to be continuous with the rear portion of the bottom plate 26 of the intermediate conveying apparatus 22, and smoothly conveys the threshing material conveyed rearward by the raking member 25, rearward without leaking it downward.

A portion rearward of the raking section 39 of the second threshing drum 28 is provided with a threshing processing section 43.

The threshing processing section 43 includes a first threshing processing section 44 on the front side and a second threshing processing section 45 on the rear side, and the shapes of the threshing teeth of the first threshing processing section 44 and the second threshing processing section 45 are different from each other.

The configuration of the threshing processing section 43 will be described.

As shown in FIG. 4, the threshing processing section 43 includes a front support member 41 joined to a portion of the rotary support shaft 29 corresponding to the rear part of the raking section 39, a rear support member 46 joined to the rear end of the rotary support shaft 29, and three intermediate support members 47a, 47b, and 47c that are joined to the intermediate portion in the front-rear direction of the rotary support shaft 29 at intervals in the axial direction.

The threshing processing section 43 includes a first threshing processing section 44 having six front frame bodies 30a located frontward of the second intermediate support member 47b in the frame body 30, and a second threshing processing section 45 having six rear frame bodies 30b located rearward of the second intermediate support member 47b in the frame body 30.

The front frame bodies 30a and the rear frame bodies 30b are obtained by dividing a single frame body having a front-rear length that spans the front support member 41 and the rear support member 46 in two pieces in the front-rear direction at a position corresponding to the second intermediate support member 47b. The front frame bodies 30a and the rear frame bodies 30b are set to have the same length.

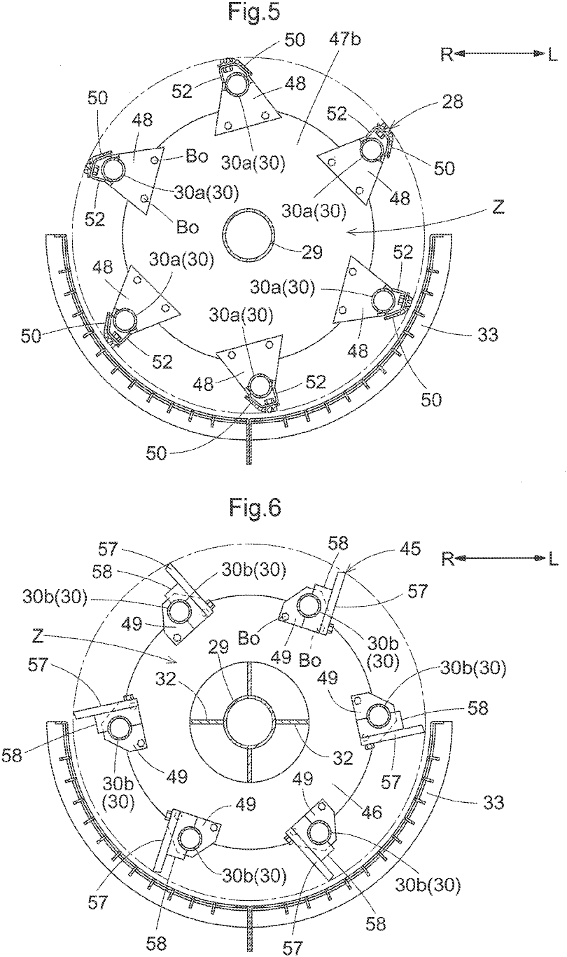

As shown in FIG. 5, the six front frame bodies 30a are arranged side by side in the peripheral direction of the second threshing drum 28 at regular intervals. A plate-shaped joining member 48 is joined by welding to the front end of each front frame body 30a, and the joining member 48 is joined to the front supporting member 41 with bolts Bo. Similarly to the front end, the rear end of the front frame body 30a is joined by welding to a plate-shaped connecting member 48, and the joining member 48 is joined to the second intermediate support member 47b with bolts Bo.

As shown in FIG. 6, the six rear frame bodies 30b are arranged side by side in the peripheral direction of the second threshing drum 28 at regular intervals. A plate-shaped joining member 49 similar to the front frame body 30a is joined by welding to the front end portion of each rear frame body 30b, and the joining member 49 is joined to the second intermediate support member 47b with bolts Bo. Similarly to the front end, the rear end of the rear frame body 30b is joined to the rear support member 46 via a plate-shaped joining member 49 with bolts Bo.

As described above, the front frame bodies 30a and the rear frame bodies 30b have the same length and the same attachment structure. Accordingly, the front frame bodies 30a can be attached also to the second threshing processing section 45, and the rear frame bodies 30b can be attached also to the first threshing processing section 44. That is, it is possible to replace them by disconnecting the bolts Bo and changing the front-rear position.

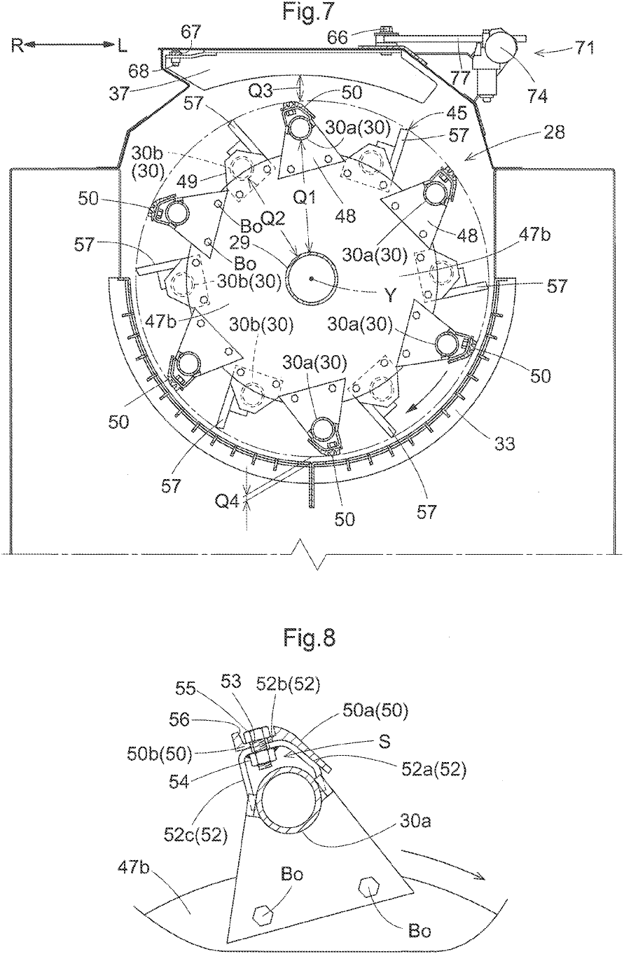

An interval Q1 in the radial direction between the front frame body 30a and the rotary support shaft 29 and an interval Q2 in the radial direction between the rear frame body 30b and the rotary support shaft 29 are different from each other. To add description, as shown in FIG. 7, the front frame body 30a is arranged radially outward relative to the rear frame body 30b. Accordingly, the interval Q1 in the radial direction between the front frame body 30a and the rotary support shaft 29 is larger than the interval Q2 in the radial direction between the rear frame body 30b and the rotary support shaft 29.

Both the front frame bodies 30a and the rear frame bodies 30b are arranged in a distributed manner at equal intervals in the peripheral direction, and the front frame bodies 30a and the rear frame bodies 30b are arranged in different phases in the peripheral direction. Specifically, the front frame bodies 30a and the rear frame bodies 30b are arranged with their phases shifted in the peripheral direction such that the rear frame bodies 30b are each located at a substantially intermediate position in the peripheral direction between the two adjacent front frame bodies 30a.

By arranging in this way, the joining member 48 on the front frame body 30a side and the joining member 49 on the rear frame body 30b side can be displaced in the peripheral direction, and the task of joining to the second intermediate support member 47b can be performed easily.

The first threshing processing section 44 is provided with first threshing teeth 50 that have recesses and protrusions on the surface and thresh crops with use of the shape of the recesses and protrusions on the surface. The first threshing teeth 50 also have the same configuration as the threshing teeth 19 provided on the first threshing drum 17. That is, as shown in FIG. 9, the first threshing teeth 50 are composed of rasp threshing teeth that have a large number of recesses and protrusions 51 formed on the surface and thresh crops with use of the shape of the recesses and protrusions on the surface.

As shown in FIGS. 5 and 8, a rotation direction upstream portion 50a of the first threshing teeth 50 is formed with a smooth outer peripheral surface, and is provided in an inclined shape such that the interval between the rotation direction upstream portion 50a and the second receiving net 33 in the radial direction becomes narrower toward the downstream side in the rotation direction. A rotation direction downstream portion 50b of the first threshing teeth 50 has an outer peripheral surface on which recesses and protrusions 51 are formed, and the interval between the rotation direction downstream portion 50b and the second receiving net 33 along the radial direction is approximately the same over the entire width in the peripheral direction.

The first threshing teeth 50 are shaped like rods extending along the longitudinal direction of the front frame body 30a. The first threshing teeth 50 are supported by a support base 52 attached to the front frame body 30a. A plurality of support bases 52 (five in the example shown in FIG. 4) are attached to the front frame body 30a at intervals along the axial direction of the second threshing drum 28.

As shown in FIG. 8, the support base 52 is constituted by a plate body that is bent into a substantial U shape in a view in the direction of the rotation axis, and both ends are joined by welding to the outer peripheral surface of the front frame body 30a. Also, the support base 52 includes an upstream support portion 52a that has one end welded to the outer peripheral surface of the front frame body 30a and supports the rotation direction upstream portion 50a of the first threshing teeth 50, a downstream support portion 52b that is continuous with the upstream support portion 52a and supports the rotation direction downstream portion 50b of the first threshing teeth 50, and an extended portion 52c that is continuous with the downstream support portion 52b and has another end welded to the outer peripheral surface of the front frame body 30a. The upstream support portion 52a is provided in a shape extending along the rotation direction upstream portion 50a of the first threshing teeth 50, and the downstream support portion 52b is provided in a shape extending along the rotation direction downstream portion 50b of the first threshing teeth 50. A gap S is formed between the downstream support portion 52b and the front frame body 30a.

The first threshing teeth 50 are detachably supported on the support base 52. As shown in FIGS. 8 and 9, a bolt hole 53 is formed at a position corresponding to the support base 52 in the rotation direction downstream portion 50b of the first threshing teeth 50. The inner surface of the portion of the downstream support portion 52b corresponding to the bolt hole 53 includes a welded nut 54. A bolt 55 and a nut 54 mounted from the outer peripheral side fasten and fix the rotation direction downstream portion 50b of the first threshing teeth 50 and the downstream support portion 52b of the support base 52. A recess 56 into which the bolt head is inserted is formed on the outer peripheral side of the rotation direction downstream portion 50b of the first threshing teeth 50. This prevents the head of the bolt 55 from protruding radially outward.

The second threshing processing section 45 includes second threshing teeth 57 extending radially outward in a rod shape. As shown in FIG. 10, the second threshing teeth 57 are constituted by a plate body having a substantially U-shaped cross section, and are provided in a longitudinally elongated shape along the radial direction. The second threshing teeth 57 are joined and supported by fastening a bolt 59 to a bracket 58 fixed to the outer peripheral portion of the rear frame body 30b. The bracket 58 is constituted by a plate body having a substantially U-shaped cross section, and both side faces 58a of the bracket 58 are welded to the outer periphery of the rear frame body 30b. The brackets 58 are provided at appropriate intervals in the longitudinal direction of the rear frame body 30b. An intermediate portion 58b between the side faces 58a on both sides of the bracket 58 is formed in a planar shape, and is formed in an inclined orientation in which the rear portion is located on the downstream side in the rotation direction.

The second threshing teeth 57 are fixed to the bracket 58 by tightening a bolt 59 while abutting on the intermediate portion 58b of the bracket 58 from the outside. The intermediate portion 57a of the second threshing teeth 57 is formed in a planar shape, and the outer surface of the intermediate portion 57a forms a threshing surface 57b that acts on crops. The fixing portion of the second threshing teeth 57 to the bracket 58, specifically, the formation locations of the insertion holes 60 through which the bolts 59 are inserted, are formed at two locations equidistant from the center in the longitudinal direction.

By being configured in this way, when the radial outer end of the second threshing teeth 57 is worn due to long-term threshing, the direction of the second threshing teeth 57 can be reversed in the longitudinal direction, and can be fixed by a bolt in the other insertion hole 60.

As shown in FIG. 6, the second threshing teeth 57 are inclined so as to be located on the downstream side in the rotation direction of the second threshing drum 28 toward the outside in the radial direction in a view in the axial direction of the rotary support shaft 29. In addition, the intermediate portion 58b of the bracket 58 to which the second threshing teeth 57 are attached is formed in an inclined orientation of being located on the downstream side in the rotation direction toward the rear.

Accordingly, the threshing surface 57b of the second threshing teeth 57 is formed in an inclined orientation of being located on the downstream side in the rotation direction toward the rear, and is inclined so as to be located on the downstream side in the rotation direction of the second threshing drum 28 toward the outside in the radial direction in a view in the axial direction of the rotary support shaft 29.

As shown in FIG. 7, in a view in the axial direction of the rotary support shaft 29, the path of the outer end of the second threshing drum 28 in the first threshing processing section 44, that is, the movement path of the radial outer end of the first threshing teeth 50, and the path of the outer end of the second threshing drum 28 in the second threshing processing section 45, that is, the movement path of the radial outer end of the second threshing teeth 57, are at the same position.

The second threshing drum 28 is formed in a basket shape with an internal space Z that is in communication with the outer peripheral space through the space between the front frame bodies 30a and the space between the rear frame bodies 30b. Accordingly, the second threshing drum 28 allows the processing material to enter the internal space Z during threshing, whereby it is possible to avoid an excessive drive load due to the second threshing drum 28.

As shown in FIG. 1, below the first threshing section 15 and the second threshing section 16, a sorting section 61 that sorts the threshing material leaked from the first receiving net 21 and threshing material leaked from the second receiving net 33 into grains, grains with branches (secondary products), other stalk waste, debris, and the like while swinging and transferring the threshing material. The sorting section 61 includes a sorting fan 62 that supplies sorting air, a grain recovery section 63 that recovers grains, and a secondary product recovery section 64 that recovers secondary products and returns them to the threshing chamber 27.

The sorting section 61 includes a grain pan 65 extending from the region below the first threshing section 15 to the region below the second threshing section 16. The rear end of the grain pan 65 extends to a position below the front end of second receiving net 33.

The grain pan 65 can transfer the threshing material that has leaked down from the first receiving net 21 of the first threshing section 15 to the region below the second threshing section 16 as-is. As a result, the sorting can be efficiently performed together with the threshing material leaked from the second receiving net 33 of the second threshing section 16.

### Debris Transport Valves

Next, the debris transport valves 37 will be described.

As shown in FIG. 12, a front end debris transport valve 37a located frontmost among the plurality of debris transport valves 37 is provided above the raking section 39 in the second threshing drum 28. The feed angle of the front end debris transport valve 37a is fixed. Accordingly, the front end debris transport valve 37a corresponds to a fixed debris transport valve.

Of the plurality of debris transport valves 37 attached to the top plate 36, the plurality of debris transport valves 37 other than the front end debris transport valve 37a are attached in such a manner that the feed angle can be changed. Among the plurality of debris transport valves 37, the respective feed angles of a plurality of front debris transport valves 37b (four in the example shown in FIG. 12) that are located frontward and a plurality of rear debris transport valves 37c (four in the example shown in FIG. 12) that are located rearward can be simultaneously changed separately.

The plurality of front debris transport valves 37b are provided on the top plate 36 at positions corresponding to the first threshing processing section 44, and the plurality of rear debris transport valves 37c are provided on the top plate 36 at positions corresponding to the second threshing processing section 45. That is, the plurality of front debris transport valves 37b are provided on the first top plate 36A, and the plurality of rear debris transport valves 37c are provided on the second top plate 36B. Among the plurality of front debris transport valves 37b, the front debris transport valve 37b located at the rear end can be switched to enter the region below the second top plate 36B.

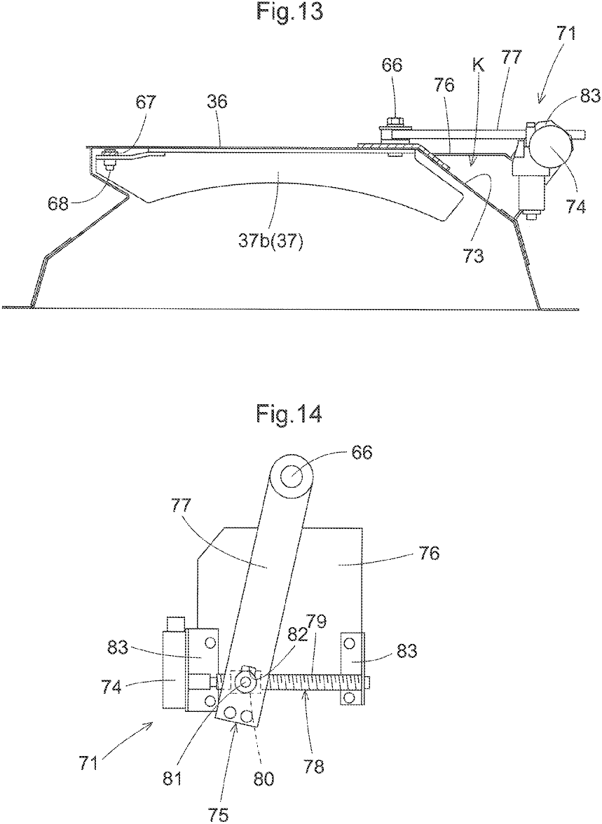

As shown in FIGS. 12 and 13, the plurality of front debris transport valves 37b and the plurality of rear debris transport valves 37c are located on the inner surface side of the top plate 36 and swingably supported via swinging support point shafts 66. The swinging support point shafts 66 are provided on the left sides of the front debris transport valves 37b and the rear debris transport valves 37c. An interlocking link 67 is joined via a joining pin 68 to the right free end of each of the plurality of front debris feeding valves 37b. That is, the plurality of front debris transport valves 37b are joined by the interlocking link 67 so as to swing in a linked manner in the same swinging direction.

Also, an interlocking link 69 is joined via a joining pin 70 to the right free end of each of the plurality of rear debris transport valves 37c. That is, the plurality of rear debris transport valves 37c are linked by the interlocking link 69 so as to swing in a linked manner in the same swinging direction.

A first angle adjusting mechanism 71 capable of simultaneously changing the feed angles of the plurality of front debris transport valves 37b, and a second angle adjusting mechanism 72 capable of simultaneously changing the feed angles of the plurality of rear debris transport valves 37c are provided.

As shown in FIG. 13, an inclined surface portion 73 in a downward inclined orientation in which the rearward side is located downward is formed at the left end of the top plate 36. The first angle adjusting mechanism 71 and the second angle adjusting mechanism 72 are arranged in an upper space K having a triangular cross section, which is formed directly above the inclined surface portion 73.

Since the first angle adjusting mechanism 71 and the second angle adjusting mechanism 72 have the same configuration, the configuration of the first angle adjusting mechanism 71 will be described below, and the description of the second angle adjusting mechanism 72 will be omitted.

The first angle adjusting mechanism 71 includes an electric motor 74 serving as a driving motor and a link mechanism 75 that joins the electric motor 74 and the front debris transport valve 37b to each other. The electric motor 74 is supported by a support base 76 fixed to the top plate 36.

The link mechanism 75 includes an adjustment lever 77 extending laterally outward from a swinging support point shaft 66 of one of the plurality of front debris transport valves 37b, and an operation mechanism 78 for swinging the lever 77 back and forth with use of the driving of the electric motor 74. The operating mechanism 78 includes a screw shaft 79 that is rotationally driven by the electric motor 74, and a female screw member 80 that moves in the front-rear direction as the screw shaft 79 rotates, and an operation pin 81 provided facing upward on the female screw member 80 is engaged through an elongated insertion hole 82 formed in the adjustment lever 77.

The screw shaft 79 extends in the body front-rear direction and is rotatably supported by front and rear support brackets 83 fixed to the support base 76. The electric motor 74 is supported by a support bracket 83 on the front side.

When the screw shaft 79 is rotated by the driving of the electric motor 74, the female screw member 80 moves back and forth along with it, and the adjustment lever 77 swings back and forth. Then, the plurality of front debris transport valves 37b are swung by the interlocking link 67. That is, it is possible to adjust the feed angles of the plurality of front debris transport valves 37b.

As shown in FIG. 7, an interval Q3 in the radial direction between the movement path of the radial outer end of the second threshing drum 28 and the radial inner end of the debris transport valve 37 is greater than an interval Q4 in the radial direction between the movement path of the radial outer end of the second threshing drum 28 and the radial inner end of the second receiving net 33. In this manner, the drive load on the second threshing drum 28 can be minimized while favorably performing threshing.

### Other Embodiments

(1) In the above embodiment, the rearward-rising inclination angle θ1 of the virtual line LN connecting the lower end position of the first threshing section 15 and the lower end position of the intermediate conveying device 22 is set to be greater than the rearward-rising inclination angle θ2 of the second threshing section 16. However, instead of this configuration, the rearward-rising inclination angle θ1 and the rearward-rising inclination angle θ2 may be set to the same angle, and the rearward-rising inclination angle θ1 may be set to an angle smaller than the rearward-rising inclination angle θ2.

(2) In the above embodiment, the rear end of the grain pan 65 extends to a position below the front end of the second receiving net 33, but instead of this configuration, the rear end of the grain pan 65 may extend to a position below a location toward the front relative to the front end of the second receiving net 33, and the length can be changed as appropriate. Also, instead of providing such a grain pan 65, a sorting device dedicated to the first threshing section 15 for sorting grains of the threshing material leaked from the first receiving net 21 may be provided.

(3) In the above embodiment, the raking section 39 having the spiral blades 38 is provided in the front part of the second threshing drum 28, but the raking section 39 need not be provided.

(4) In the above-described embodiment, the horizontal-feeding intermediate conveying apparatus 22 including a drum is provided between the first threshing section 15 and the second threshing section 16, but instead of this configuration, the intermediate conveying apparatus 22 may be a conveying apparatus including an endless rotating chain, an endless rotating belt, or the like, and the threshing material may be conveyed as-is from the first threshing section 15 to the second threshing section 16 without including such an intermediate conveying apparatus 22.

(5) In the above embodiment, the second threshing section 16 includes the first threshing processing section 44 having the first threshing teeth 50 and the second threshing processing section 45 having the second threshing teeth 57. However, instead of this configuration, the first threshing teeth 50 may be provided in all regions, and the second threshing teeth 57 may be provided in all regions.

(6) In the above embodiment, a round steel pipe is used as the frame body 30, but instead of this configuration, various rod-shaped members such as round steel, a rectangular steel rod, and a rectangular steel pipe can be used as the frame body 30.

(7) In the above-described embodiment, the first threshing teeth (rasp threshing teeth) 50 have a rod shape extending along the longitudinal direction of the frame body 30, but instead of this configuration, the first threshing teeth 50 may include a plurality of small threshing teeth that are short in the longitudinal direction of the frame body 30, at intervals.

(8) In the above embodiment, a plurality of support bases 52 are attached to the frame body 30 at intervals along the axial direction of the second threshing drum 28, but instead of this configuration, the support base 52 may have a rod shape extending along the longitudinal direction of the frame body 30.

(9) In the above embodiment, the first threshing teeth (rasp threshing teeth) 50 are detachably supported on the support base 52, but instead of this configuration, the first threshing teeth 50 may be attached in a fixed state to the support base 52, or the first threshing teeth 50 may be supported by the frame body 30.

(10) In the above embodiment, the interval between the rotation direction upstream portion 50a of the first threshing teeth (rasp threshing teeth) 50 and the second receiving net 33 along the radial direction is wider compared to the interval between the rotation direction downstream portion 50b and the second receiving net 33. However, instead of this configuration, the intervals between the rotation direction upstream portion 50a and the rotation direction downstream portion 50b of the first threshing teeth (rasp threshing teeth) 50 and the second receiving net 33 along the radial direction may be the same.

(11) In the above embodiment, the first threshing teeth (rasp threshing teeth) 50 include the rotation direction upstream portion 50a, which is a smooth outer peripheral surface, but such a rotation direction upstream portion 50a need not be included.

(12) In the above embodiment, the first threshing teeth (rasp threshing teeth) 50 are fixed to the support base 52 by the bolts 55 and the nuts 54, but instead of this configuration, the support configuration can be changed in various ways, such as a configuration in which the first threshing teeth (rasp threshing teeth) 50 are fixed by rivets, and a configuration in which the threshing teeth (rasp threshing teeth) 50 are fixed by welding.

(13) In the above embodiment, the first threshing teeth (rasp threshing teeth) 50 are included in only the first threshing processing section 44, which is the front half of the second threshing drum 28. However, instead of this configuration, the first threshing teeth (rasp threshing teeth) 50 may be included over the entire range of the second threshing drum 28 including the first threshing processing section 44 and the second threshing processing section 45.

(14) In the above embodiment, the first threshing processing section 44 includes the first threshing teeth 50 that have recesses and protrusions formed on the surface thereof, and thresh the crops with use of the shape of the recesses and protrusions on the surface, and the second threshing processing section 45 includes the second threshing teeth 57 that extend in rod shapes radially outward. However, instead of this configuration, the first threshing processing section 44 may include the second threshing teeth 57, and the second threshing processing section 45 may include the first threshing teeth 50.

(15) In the above-described embodiment, the first threshing teeth 50 are in a rod shape extending along the longitudinal direction of the frame body 30. However, instead of this configuration, as the first threshing teeth 50, a plurality of short-shaped threshing teeth may be provided at intervals along the longitudinal direction of the frame body 30, and various threshing teeth may be used instead of rasp threshing teeth with recesses and protrusions formed in the surface, such as threshing teeth having short rod-shaped members.

(16) In the above embodiment, the second threshing teeth 57 are in a plate shape having a substantially U-shaped cross-sectional shape. However, instead of this configuration, threshing teeth in various forms, such as a round rod shape, a rectangular rod shape, a round pipe material, and a rectangular pipe shape, can be used as the second threshing teeth. In short, it is sufficient that the first threshing processing section 44 and the second threshing processing section 45 have different shapes of threshing teeth.

(17) In the above embodiment, the path of the outer end of the threshing drum in the first threshing processing section 44 and the path of the outer end of the threshing drum in the second threshing processing section 45 are at the same position, but they may be at mutually different positions.

(18) In the above-described embodiment, the second threshing teeth 57 are inclined such that the radial outer side is located downstream in the rotation direction, and the threshing surface 57b of the second threshing teeth 57 has an inclined orientation in which the rear portion is located downstream in the rotation direction. However, instead of this configuration, various modes may be implemented, such as a configuration in which the second threshing teeth 57 extend straight in the radial direction, a configuration in which the threshing surface extends along the rotation direction, and a configuration in which the threshing surface is in an inclined orientation in which the rear portion is located downstream in the rotation direction.

(19) In the above embodiment, the second threshing teeth 57 extend linearly along the longitudinal direction of the rear frame body 30b. However, instead of this configuration, a plurality of second threshing teeth 57 may be attached at intervals in the longitudinal direction of the rear frame body 30b and arranged side by side in a spiral shape around the outer periphery of the rear frame body 30b.

(20) In the above-described embodiment, the front frame body 30a is attachable to the second threshing processing section 45 as well, and the rear frame body 30b is attachable to the first threshing processing section as well. However, instead of the configuration, the front frame body 30a and the rear frame body 30b may have different configurations and may be irreplaceable with each other.

### INDUSTRIAL APPLICABILITY

The present invention is applicable not only to combines for harvesting rice, wheat, buckwheat, and the like, but also to various harvesters for harvesting corn. Moreover, the present invention can be applied to a threshing apparatus for threshing harvested crops.

Description of Reference Signs

| | |
|---|---|
| 10 | Reaping section (harvesting section) |
| 11 | Feeder (crop conveying apparatus) |
| 15 | First threshing section |
| 16 | Second threshing section |
| 17 | First threshing drum |
| 21 | First receiving net |
| 22 | Intermediate conveying apparatus |
| 27 | Threshing chamber |
| 28 | Second threshing drum (threshing drum) |
| 29 | Rotary support shaft |
| 30 | Frame body |
| 30 a | Frame body |
| 31 | Threshing teeth |
| 33 | Second receiving net (receiving net) |
| 38 | Spiral blade |
| 39 | Raking section |
| 44 | First threshing processing section |
| 45 | Second threshing processing section |
| 50 | First threshing teeth (rasp threshing teeth) |
| 50 a | Rotation direction upstream portion |
| 50 b | Rotation direction downstream portion |
| 51 | Recesses and protrusions |
| 52 | Support base |
| 52 a | Upstream support portion |
| 52 b | Downstream support portion |
| 54 | Nut |
| 55 | Bolt |
| 57 | Second threshing teeth |
| 57 b | Threshing surface |
| 60 | Fixing portion |
| 61 | Sorting section |
| 65 | Grain pan |
| Q1, Q2 | Interval |

1. A threshing apparatus comprising:
a first threshing section configured to thresh an introduced crop; and
a second threshing section provided rearward of the first threshing section and configured to thresh a threshing material threshed by the first threshing section, wherein;
the first threshing section comprises a first threshing drum configured to rotate about a left-right-oriented axis,
the second threshing section comprises a second threshing drum configured to rotate about a body front-rear-oriented axis, and
the second threshing drum comprises:
a rotary support shaft rotatably provided in an orientation along a front-rear direction;
a plurality of rod-shaped frame bodies arranged side by side extending along the front-rear direction and at an interval in a peripheral direction, radially outward of the rotary support shaft; and
threshing teeth attached to the frame bodies.

2. The threshing apparatus according to claim 1, further comprising:
an intermediate conveying apparatus configured to convey threshing material threshed by the first threshing section to the second threshing section.

3. The threshing apparatus according to claim 2,
wherein the intermediate conveying apparatus conveys the threshing material to the second threshing section without leaking the threshing material downward.

4. The threshing apparatus according to claim 2,
wherein a lower end position of the intermediate conveying apparatus is at a location higher than a lower end position of the first threshing section, and
wherein the second threshing section provided continuously with a rear end of the intermediate conveying apparatus is provided in a rearward-rising inclined orientation.

5. The threshing apparatus according to claim 4,
wherein a rearward-rising inclination angle of a virtual line connecting the lower end position of the first threshing section and the lower end position of the intermediate conveying apparatus is set to be greater than a rearward-rising inclination angle of the second threshing section.

6. The threshing apparatus according to claim 1, further comprising:
a raking section having a spiral blade at a front part of the second threshing drum; and
a guide body located below the raking section and configured to receive the threshing material raked rearward by the raking section and guide the threshing material rearward without leaking the threshing material downward.

7. The threshing apparatus according to claim 1, further comprising:
a first receiving net provided along an outer periphery of the first threshing drum;
a second receiving net provided along an outer periphery of the second threshing drum; and
a sorting section configured to sort the threshing material leaked by the first receiving net and the threshing material leaked by the second receiving net,
wherein the sorting section comprises a grain pan that extends along a region below the second threshing section from a region below the first threshing section.

8. The threshing apparatus according to claim 7,
wherein a rear end of the grain pan extends to a position below a front end of the second receiving net.

9. The threshing apparatus according to claim 1,
wherein the second threshing drum comprises a first threshing processing section on a front side and a second threshing processing section on a rear side,
wherein the frame body in the first threshing processing section and the frame body in the second threshing processing section are provided in a divided state, and
wherein the frame body in the first threshing processing section and the frame body in the second threshing processing section are provided in different phases in a peripheral direction.

10. The threshing apparatus according to claim 1,
wherein the second threshing drum comprises a first threshing processing section on a front side and a second threshing processing section on a rear side, and
wherein the threshing teeth of the first threshing processing section and the threshing teeth of the second threshing processing section have mutually different shapes.

11. A harvester comprising:
a harvesting section provided on a vehicle body front part and configured to harvest a crop;
a crop conveying apparatus configured to convey the crop harvested by the harvesting section rearward;
a first threshing section configured to thresh the crop conveyed by the crop conveying apparatus; and
a second threshing section configured to thresh a threshing material threshed by the first threshing section, wherein;
the first threshing section comprises a first threshing drum configured to rotate about a left-right-oriented axis,
the second threshing section comprises a second threshing drum configured to rotate about a body front-rear-oriented axis, and
the second threshing drum comprises:
a rotary support shaft rotatably provided in an orientation along a front-rear direction;
a plurality of rod-shaped frame bodies arranged side by side extending along the front-rear direction and at an interval in a peripheral direction, radially outward of the rotary support shaft; and
threshing teeth attached to the frame bodies.

12. The harvester according to claim 11, further comprising;
an intermediate conveying apparatus configured to convey threshing material threshed by the first threshing section to the second threshing section.

13. A threshing apparatus comprising:
a threshing chamber; and
a threshing drum rotatably provided in the threshing chamber and configured to perform threshing of a crop introduced into a front part of the threshing chamber,
wherein the threshing drum comprises:
a rotary support shaft rotatably provided in an orientation along a front-rear direction of the threshing chamber,
a plurality of rod-shaped frame bodies arranged side by side extending along the front-rear direction and at an interval in a peripheral direction, radially outward of the rotary support shaft, and
threshing teeth fixed to the frame bodies, and
wherein the threshing teeth are rasp threshing teeth with recesses and protrusions formed on a surface thereof, and are configured to thresh the crop with use of the shape of the recesses and protrusions on the surface.

14. The threshing apparatus according to claim 13,
wherein the rasp threshing teeth are supported on a support base attached to the frame body.

15. The threshing apparatus according to claim 14,
wherein a plurality of the support bases are attached to the frame bodies at intervals along an axial direction of the threshing drum.

16. The threshing apparatus according to claim 14, wherein the rasp threshing teeth are removably supported by the support base.

17. The threshing apparatus according to claim 13,
wherein the rasp threshing teeth are in a rod shape extending along a longitudinal direction of the frame body.

18. The threshing apparatus according to claim 13,
wherein a receiving net is included along an outer periphery of the threshing drum, and
wherein an interval between a rotation direction upstream portion of the rasp threshing teeth and the receiving net along a radial direction is wider compared to an interval between a rotation direction downstream portion of the rasp threshing teeth and the receiving net.

19. The threshing apparatus according to claim 18,
wherein the rotation direction upstream portion of the rasp threshing teeth has a smooth outer peripheral surface, and is in an inclined shape such that an interval from the receiving net along a radial direction narrows toward the rotation direction downstream side, and
wherein a rotation direction downstream portion of the rasp threshing teeth has recesses and protrusions formed on a surface thereof, and an interval between the rotation direction downstream portion and the receiving net along a radial direction is approximately the same over the entire width in the peripheral direction.

20. The threshing apparatus according to claim 13, wherein:
the rasp threshing teeth are attached to a support base supported on the frame body,
the support base comprises an upstream support portion supporting a rotation direction upstream portion of the rasp threshing teeth, and a downstream support portion supporting a rotation direction downstream portion of the rasp threshing teeth,
the upstream support portion is in a shape extending along the rotation direction upstream portion of the rasp threshing teeth, and
the downstream support portion is in a shape extending along the rotation direction downstream portion of the rasp threshing teeth.

21. The threshing apparatus according to claim 20,
wherein the support base is attached with a gap formed between the downstream support portion and the frame body, and
wherein the rotation direction downstream portion of the rasp threshing teeth and the downstream support portion are supported by being fastened by a bolt mounted from above and a nut included in the gap between the downstream support portion and the frame body.

22. The threshing apparatus according to claim 13,
wherein the threshing drum comprises another threshing processing section rearward of the threshing processing section having the rasp threshing teeth.

23. A threshing apparatus comprising:
a threshing chamber; and
a threshing drum that is rotatably provided in the threshing chamber and configured to perform threshing of a crop introduced into a front part of the threshing chamber,
wherein the threshing drum comprises:
a rotary support shaft rotatably provided in an orientation along a front-rear direction of the threshing chamber;
a plurality of rod-shaped frame bodies arranged side by side extending along the front-rear direction and at an interval in a peripheral direction, radially outward of the rotary support shaft, and
threshing teeth fixed to the frame bodies,
wherein the threshing drum comprises a first threshing processing section in a front portion and a second threshing processing section in a rear portion, and
wherein the threshing teeth of the first threshing processing section and the second threshing processing section have mutually different shapes.

24. The threshing apparatus according to claim 23,
wherein the first threshing processing section comprises one of first threshing teeth that have recesses and protrusions on a surface thereof and thresh a crop with use of the shape of the recesses and protrusions on the surface, and second threshing teeth that extend radially outward in a rod shape, and
wherein the second threshing processing section comprises the other of the first threshing teeth and the second threshing teeth.

25. The threshing apparatus according to claim 24,
wherein the first threshing processing section comprises the first threshing teeth, and
wherein the second threshing processing section comprises the second threshing teeth.

26. The threshing apparatus according to claim 24, wherein the first threshing teeth are in a rod shape extending along a longitudinal direction of the frame body.

27. The threshing apparatus according to claim 24,
wherein a path of an outer end of the threshing drum in the first threshing processing section and a path of an outer end of the threshing drum in the second threshing processing section are at the same position in a view in an axial direction of the rotary support shaft.

28. The threshing apparatus according to claim 27,
wherein an interval in a radial direction between the frame body and the rotary support shaft in the first threshing processing section and an interval in a radial direction between the frame body and the rotary support shaft in the second threshing processing section are different from each other.

29. The threshing apparatus according to claim 24,
wherein the second threshing teeth are inclined such that a radial outer side thereof is located on a rotation direction downstream side of the threshing drum in a view in the axial direction of the rotary support shaft.

30. The threshing apparatus according to claim 24,
wherein the second threshing teeth have a planar threshing surface, and
wherein the threshing surface is in an inclined orientation in which a rear portion thereof is located downstream in a rotation direction.

31. The threshing apparatus according to claim 24,
wherein the second threshing teeth are in a vertically elongated shape that is elongated in a radial direction and fixing portions for fixing to the frame body are formed at locations spaced apart from a center in a longitudinal direction by an equal distance.

32. The threshing apparatus according to claim 24,
wherein a plurality of the second threshing teeth are attached at intervals in the longitudinal direction of the frame body and are arranged side by side in a spiral shape around an outer periphery of the frame body.

33. The threshing apparatus according to claim 23,
wherein the frame body in the first threshing processing section and the frame body in the second threshing processing section are provided in a divided state, and
wherein the frame body in the first threshing processing section and the frame body in the second threshing processing section are provided in different phases in a peripheral direction.

34. The threshing apparatus according to claim 23,
wherein the frame body in the first threshing processing section and the frame body in the second threshing processing section are provided in a divided state, and
wherein the frame body in the first threshing processing section is attachable to the second threshing processing section as well, and the frame body in the second threshing processing section is attachable to the first threshing processing section as well.
